(19) United States
(12) Patent Application Publication
(10) Pub. No.: US 2007/0216113 A1
(43) Pub. Date: Sep. 20, 2007

(54) Expansion Chucking Device

(76) Inventors: Andreas Schuster, Wustenrot/Neulautern (DE); Gerhard Michler, Ilsfeld (DE); Thomas Retzbach, Bonnigheim (DE); Rainer Sigmund, Lauffen (DE)

Correspondence Address: BERENATO, WHITE & STAVISH, LLC, 6550 ROCK SPRING DRIVE, SUITE 240, BETHESDA, MD, 20817, US

(21) Appl. No.: 11/547,468

(22) PCT Filed: Apr. 5, 2005
(86) PCT No.: PCT/EP05/03560

§ 371 Date: Oct. 5, 2006

(30) Foreign Application Priority Data
Apr. 6, 2004 (EP) 04008296.8

(51) Int. Cl. B23B 5/22

(52) U.S. Cl. 279/2.08

(57) ABSTRACT

The present invention relates to an expansion chucking device having: a base body (2); an expansion sleeve (4) provided at an axial end region of the base body (2), which sleeve forms a central receptacle (5) for a component to be chucked; and a chucking ring (6) that surrounds the expansion sleeve (4), forming an annular pressure chamber (7) located therebetween, and is thread-joined to the base body (2), the pressure chamber (7) being filled with a hydraulic medium (11) and the expansion sleeve (4) being capable of being elastically deformed in order to secure a component in the receptacle (5) by the fact that the chucking ring (6) is axially displaced by rotation with respect to the base body (2), with a reduction in the volume of the pressure chamber (7), wherein multiple slits (4b) are embodied in the expansion sleeve (4) which extend in the axial direction and are spaced apart from one another when viewed in the circumferential direction, the expansion sleeve (4) being sealed off with respect to the pressure chamber (7) in order to prevent any entry of hydraulic medium (11) into the slits (4a).

The present invention relates to an expansion chucking device having: a base body; an expansion sleeve provided at an axial end region of the base body, which sleeve forms a central receptacle for a component to be chucked; and a chucking ring that surrounds the expansion sleeve, forming an annular pressure chamber located therebetween, and is thread-joined to the base body, the pressure chamber being filled with a hydraulic medium and the expansion sleeve being capable of being elastically deformed in order to secure a component in the receptacle by the fact that the chucking ring is axially displaced by rotation with respect to the base body, with a reduction in the volume of the pressure chamber.

Expansion chucking devices of this kind are known, for example, from DE 195 25 574 C1, and are used in practice in order to secure a tool, such as, for example, a milling or drilling tool, on the working spindle of a corresponding machine tool. For that purpose, the shaft of the tool to be chucked is inserted into the receptacle of the expansion chuck, and the chucking ring is then screwed onto the expansion sleeve with a decrease in the volume of the pressure chamber, so that the sleeve becomes deformed inward by the rising pressure in the pressure chamber and secures the tool shaft in the receptacle.

The expansion sleeves of the known chucking devices are usually of thin-walled configuration so that the necessary deformation forces are kept low. The thin-walled configuration at the same time creates the disadvantage, however, that the rigidity of the expansion sleeves is not particularly high.

It is therefore the object of the invention to configure an expansion sleeve of the kind cited initially in such a way that it possesses elevated rigidity.

This object is achieved, according to the present invention, in that multiple slits are embodied in the expansion sleeve which extend in the axial direction and are spaced apart from one another when viewed in the circumferential direction, the expansion sleeve being sealed off with respect to the pressure chamber in order to prevent any entry of hydraulic medium into the slits. The result of the axial slits provided according to the present invention is that the expansion sleeve becomes “softer” in the radial direction, so that given a constant wall thickness the radial compressive forces to be applied for a deformation are reduced, or conversely given constant deformation forces the wall thickness of the expansion sleeve can be increased without thereby impairing deformability. The axial slits provided according to the present invention thus create the possibility of using expansion sleeves having a greater wall thickness and thus greater transverse rigidity, which are substantially more resistant to lateral loads and at the same time permit high expansion rates. The transverse rigidity is not decreased by the axial slits.

In a further embodiment of the invention, provision is made for the necessary sealing of the expansion sleeve with respect to the pressure space to be accomplished by way of an intermediate sleeve that, in particular, can be secured to the base body and/or to the expansion sleeve.

It has proven to be advantageous to embody the axial slits so that they are closed at their two axial ends, i.e. in particular are not configured to be open toward the front side of the expansion chucking device. In this case the axial slits can be manufactured, for example, using an electrodischarge machining method.

In the event such an intermediate sleeve is used, it should be ensured that the intermediate sleeve does not come into contact with the chucking ring, in particular at the front end of the expansion chucking device. Experiments have shown that running accuracy can otherwise be impaired.

According to a further embodiment, provision is made for the pressure chamber to be sealed at its end facing toward the base body against any emergence of hydraulic medium, by way of a sealing ring made of plastic that is sufficiently flexible to seal reliably even in the case of the high expansion rates that can be achieved with the expansion chucking device according to the present invention.

A seal of this kind is also advisable when the pressure chamber, in accordance with a further embodiment, is filled with an elastic solid body as a hydraulic medium and a sliding ring element is arranged between the elastic solid body and a pressure surface of the chucking ring in order to transfer an axial compressive force from the chucking ring to the solid body. This configuration is based on the idea of filling the pressure chamber not, as in the existing art, with a liquid hydraulic medium, but with an elastic and likewise annular solid body, so that complex sealing features can be dispensed with. The sliding ring inserted into the pressure chamber ensures that the annular solid body, in the region of its end surface facing toward the pressure surface of the chucking ring, becomes at least largely decoupled from the rotary motions of the chucking ring, and thus only compressive forces, but no frictional or torsional forces, are introduced via that end surface into the solid body. It has been found that in this fashion, extrusion of the elastic solid body material can be avoided, and wear can also be kept very low. The sliding ring, which for example can be made of a suitable metal alloy, a plastic, or a ceramic material, can moreover also simultaneously possess a sealing function.

In a further development of this embodiment of the invention, provision is made for the solid body to be made up of multiple annular element arranged to lie next to one another in the pressure space. The pressure chamber should possess at least a substantially constant inside and outside diameter.

A stop can furthermore be provided, which delimits the axial displacement travel of the chucking ring in such a way that the maximum attainable pressure inside the pressure chamber is delimited in defined fashion.

In addition, engagement means for actuation elements such as, for example, a roller spanner or sickle spanner can be provided on the chucking ring.

Lastly, the expansion chucking device according to the present invention can be used for a shaft/hub connection. It can likewise be provided in stationary fashion on a workbench or the like.

The expansion chucking device according to the present invention can moreover also be embodied as an arbor chuck. In this case it possesses a base body; an expansion sleeve provided at one axial end region of the base body; and a chucking ring that engages into the expansion sleeve, forming an annular pressure chamber located therebetween, and is thread-joined to the base body. In this configuration as an arbor chuck, the expansion sleeve is deformed outward when pressure builds up in the pressure chamber, in order secure a component slid onto the expansion sleeve.

With regard to further advantageous embodiments of the invention, reference is made to the dependent claims and to the description below of an exemplifying embodiment referring to the attached drawings, in which:

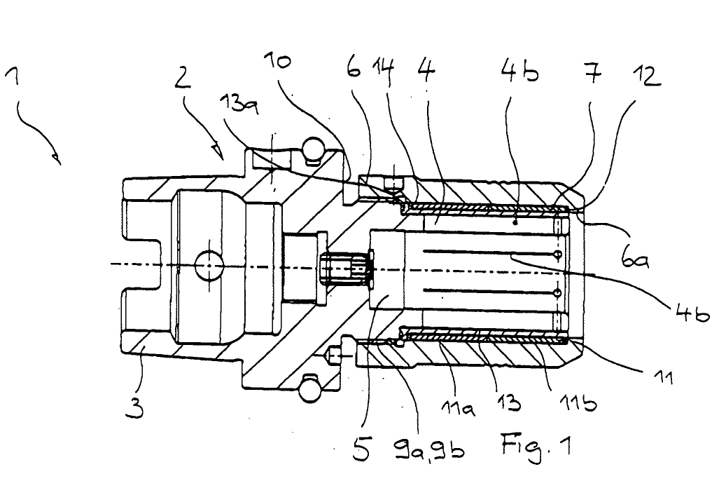

FIG. 1 shows, in longitudinal section, an embodiment of an expansion chucking device according to the present invention, embodied as an expansion chuck, in its unactuated state;

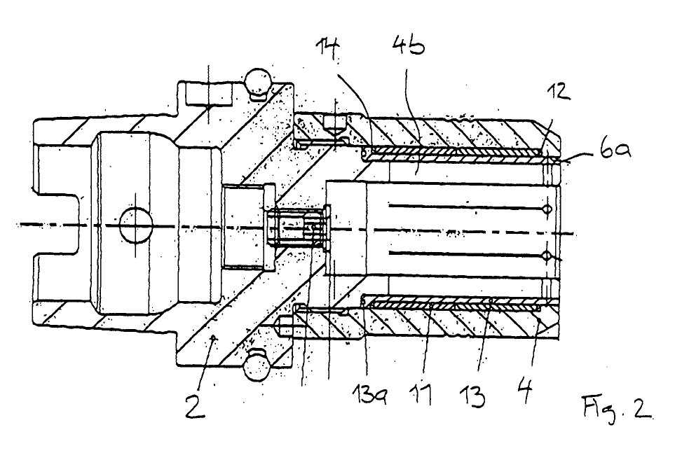

FIG. 2 shows the expansion chuck of FIG. 1 in the actuated state; and

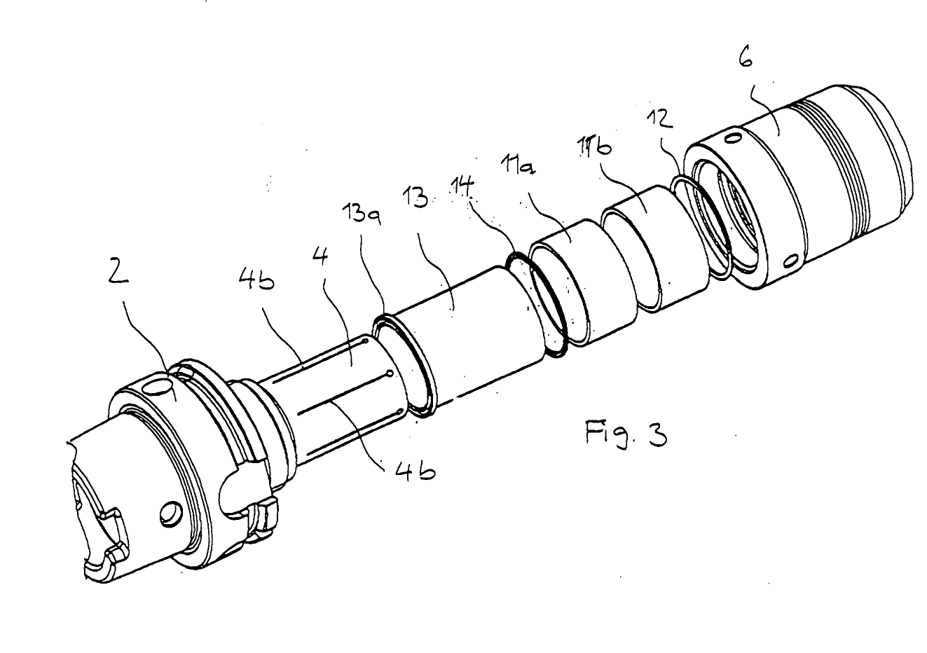

FIG. 3 is an exploded view of the expansion chuck.

FIG. 1 depicts, in longitudinal section, an embodiment of an expansion chuck 1 according to the present invention configured as a quick-release taper tool holder. Expansion chuck 1 encompasses a base body 2, made of a dimensionally stable material, which comprises at its left-side (in the drawing) end region a mounting taper 3 for chucking onto a rotationally driven working spindle of a machine tool. Provided at the other axial end of base body 2 is a thin-walled expansion sleeve 4 that here is embodied integrally with base body 2, but alternatively can also be a separate component that is fixedly joined to base body 2. Expansion sleeve 4 forms a central receptacle 5 into which a cylindrical shaft of a tool, such as, for example, a drill or milling cutter to be chucked, can be inserted.

Expansion sleeve 4 is surrounded by a chucking ring 6 embodied as a coupling nut which, at its axial end facing toward mounting taper 3, is threaded onto base body 2, for which purpose corresponding thread segments 9a, 9b are embodied on base body 2 and on the inner side of chucking ring 6. Expansion sleeve 4 and chucking ring 6 form between them an annular pressure chamber 7 having a constant inside and outside diameter, which is delimited at its axial end facing toward mounting taper 3 by a step 4b of expansion sleeve 4, and at its other axial end by a shoulder 6a of chucking ring 6. Pressure chamber 7 is filled with an elastic solid body 11 that, in the embodiment depicted, is formed by two annular elements 11a, 11b located next to one another. There is additionally provided at the right end of pressure chamber 7, between shoulder 6a of chucking ring 6 and the end surface of externally located annular element 11b facing toward that shoulder 6a, a sliding ring 12 that on the one hand decouples chucking ring 6 from solid body 11 in the region of shoulder 6a, and on the other hand functions as a sealing element.

The pressure inside pressure chamber 7 can be modified by the fact that chucking ring 6 is rotated with respect to base body and in that fashion axially displaced, so that the volume of pressure chamber 7 changes. Concretely, the arrangement is such that in the right-hand end position (shown in FIG. 1) of chucking ring 6, the volume of pressure chamber 7 is sufficiently large that elastic annular elements 11 in pressure chamber 7 are relaxed. When chucking ring 6 is screwed, out of the end position depicted in FIG. 1, onto base body 2 until it reaches the left end position 1 shown in FIG. 2, in which chucking ring 6 rests against an axial stop 10 of base body 2, the axial length of pressure chamber 7, and thus its volume, is continuously decreased. Elastic annular elements 11a to 11d are in that context elastically compressed, so that the pressure inside pressure chamber 7 is elevated and the thin-walled expansion sleeve 4 is deformed inward in order to chuck a component inserted into receptacle 5. In the context of the displacement of chucking ring 6 out of the end position shown in FIG. 1 into the end position shown in FIG. 2, substantially exclusively axial compressive forces are introduced into annular elements 11, since annular elements 11 are decoupled from chucking ring 6 at their outer circumference by the lubricant that is present, and at their end surface facing toward shoulder 6a by sliding ring 12, so that chucking ring 6 can move substantially freely with respect to solid body 11.

As is clearly evident from the drawing, expansion sleeve 4 of expansion chuck 1 according to the present invention is embodied with comparatively thick walls; it comprises six axial slits 4b that are arranged at regular spacings from one another in the circumferential direction, and pass radially through expansion sleeve 4. Slits 4b are closed at the ends, i.e. they terminate at a distance from the axial ends of expansion sleeve 4.

In the exemplifying embodiment depicted, slits 4b are embodied to be regularly spaced apart from one another in the circumferential direction, and of equal length. Also possible, however, is an irregular arrangement of slits 4b, and an embodiment with different lengths. Slits 4b are moreover electrodischarge-machined into expansion sleeve 4, starting holes 4c at the front ends of slits 4b being readily apparent in the drawing.

To prevent extruded plastic material of solid body 11 from entering into slits 4b during the chucking operation, expansion sleeve 4 is sealed with respect to pressure chamber 7 by an intermediate sleeve 13 that is slid onto expansion sleeve 4 and secured at the base-body end. The intermediate sleeve, which can be made e.g. of plastic, steel, or brass, comprises at its base-body end a radially outwardly protruding flange 13a that delimits pressure chamber 7 at its base-body end. Provided between flange 13a and solid body 11 in pressure chamber 7 is a sealing ring 14 made of plastic, which is suitable for sealing the extrusion gap between chucking ring 6 and intermediate sleeve 13 that occurs in particular at high expansion rates.

It is not apparent from the drawing that intermediate sleeve 13 does not come into contact with clamping ring 6, i.e. that an annular gap is provided between the two components in order to prevent any impairment of running accuracy.

1. An expansion chucking device having: a base body (2); an expansion sleeve (4) provided at an axial end region of the base body (2), which sleeve forms a central receptacle (5) for a component to be chucked; and a chucking ring (6) that surrounds the expansion sleeve (4), forming an annular pressure chamber (7) located therebetween, and is thread-joined to the base body (2), the pressure chamber (7) being filled with a hydraulic medium (11) and the expansion sleeve (4) being capable of being elastically deformed in order to secure a component in the receptacle (5) by the fact that the chucking ring (6) is axially displaced by rotation with respect to the base body (2), with a reduction in the volume of the pressure chamber (7),
wherein multiple slits (4b) are embodied in the expansion sleeve (4) which extend in the axial direction and are spaced apart from one another when viewed in the circumferential direction, the expansion sleeve (4) being sealed off with respect to the pressure chamber (7) in order to prevent any entry of hydraulic medium (11) into the slits (4a).

2. An expansion chucking device having: a base body (2); an expansion sleeve (4) provided at one axial end region of the base body (2); and a chucking ring (6) that engages into the expansion sleeve (4), forming an annular pressure chamber (7) located therebetween, and is thread-joined to the base body (2), the pressure chamber (7) being filled with a hydraulic medium (11) and the expansion sleeve (4) being capable of being elastically deformed in order to secure a component on the expansion sleeve (4) by the fact that the chucking ring (6) is axially displaced by rotation with respect to the base body (2), with a reduction in the volume of the pressure chamber (7),
wherein multiple slits (4b) are embodied in the expansion sleeve (4) which extend in the axial direction and are spaced apart from one another when viewed in the circumferential direction, the expansion sleeve (4) being sealed off with respect to the pressure chamber (7) in order to prevent any entry of hydraulic medium (11) into the slits (4a).

3. The expansion chucking device according to claim 1, wherein an intermediate sleeve (13) is provided for sealing of the expansion sleeve (4) with respect to the pressure space (7).

4. The expansion chucking device according to claim 3, wherein the intermediate sleeve (13) is secured to the base body (2) and/or to the expansion sleeve (4).

5. The expansion chucking device according to claim 1, wherein the axial slits (4b) are closed at their two axial ends.

6. The expansion chucking device according to claim 1, wherein the pressure chamber (7) is sealed at its end facing toward the base body (2), by way of a sealing ring (14) made of plastic, against any emergence of hydraulic medium.

7. The expansion chucking device according to claim 1, wherein the pressure chamber (7) is filled with an elastic solid body (11) as a hydraulic medium.

8. The expansion chucking device according to claim 7, wherein a sliding ring element (12) is arranged between the elastic solid body (11) and a pressure surface (6a) of the chucking ring (6) in order to transfer an axial compressive force from the chucking ring (6) to the solid body (11).

9. The expansion chucking device according to claim 8, wherein the sliding ring element (12) possesses a sealing function.

10. The expansion chucking device according to claim 7, wherein the solid body (11) comprises multiple annular elements (11a, 11b, 11c, 11d) arranged to lie next to one another.

11. The expansion chucking device according to claim 7, wherein the pressure chamber (7) possesses a substantially constant inside and/or outside diameter.

12. The expansion chucking device according to claim 1, wherein the slits (4b) are regularly spaced apart from one another when viewed in the circumferential direction of the expansion sleeve (4).
